(19) United States
(12) Patent Application Publication
(10) Pub. No.: US 2025/0253403 A1
(43) Pub. Date: Aug. 7, 2025

(54) SODIUM-ION BATTERY

(71) Applicant: SHENZHEN CAPCHEM TECHNOLOGY CO., LTD., SHENZHEN (CN)

(72) Inventors: YANG LIU, SHENZHEN (CN); ZHONGBO LIU, SHENZHEN (CN); XIAOHU AO, SHENZHEN (CN); QIANGQIANG ZHANG, SHENZHEN (CN); ZHONGTIAN ZHENG, SHENZHEN (CN)

(21) Appl. No.: 19/186,676

(22) Filed: Apr. 23, 2025

Related U.S. Application Data
(63) Continuation of application No. PCT/CN2023/124675, filed on Oct. 16, 2023.

(30) Foreign Application Priority Data
Nov. 29, 2022 (CN) 202211506814.3

(51) Int. Cl. H01M 10/0568; H01M 10/054; H01M 10/0569; H01M 50/109

(52) U.S. Cl. CPC H01M 10/0568; H01M 10/054; H01M 10/0569; H01M 50/109; H01M 2300/004

(57) ABSTRACT

A sodium-ion battery is provided, comprising a positive electrode, a negative electrode and an electrolyte. The electrolyte comprises NaFSI, and the mass percentage C of the usage amount of NaFSI relative to the electrolyte satisfies: 1%≤C≤15%. The disclosure ensures that a negative electrode has enough capacity for exertion, such that Na⁺ deintercalated from a positive electrode can be completely intercalated into the negative electrode, and the plating of Na⁺ at the negative electrode is prevented, thereby effectively inhibiting the occurrence of a sodium plating phenomenon; moreover, NaFSI is used in an electrolyte and the content range thereof is controlled, such that while the conductivity of the electrolyte is improved, the film forming stability of positive and negative sides of a battery is good, and a current collector does not corrode, thereby effectively improving the rate capability and the cycling stability of the battery.

### CROSS-REFERENCE TO RELATED APPLICATIONS

This application claims priority to Chinese application No. CN202211506814.3, filed Nov. 29, 2022 CN, the entire disclosures of these applications are incorporated herein by reference.

### TECHNICAL FIELD

The present disclosure relates to the technical field of electrochemistry, and in particular, to a sodium-ion battery.

### BACKGROUND

Due to the rapid growth in demand of clean energy and the rapid development of secondary battery technology, sodium-ion batteries, with abundant raw material resources, have attracted much attention. The principle and structure of sodium-ion batteries are similar to those of lithium-ion batteries. Compared with a lithium-ion battery, the sodium-ion battery has a wide range of resources and is low in cost, with small cost fluctuation. Moreover, wide temperature range and high safety performance of sodium-ion batteries endow them with potential for replacement. With the continuous progress of sodium-ion battery technology, sodium-ion batteries have broad growth space in the field of energy storage. Therefore, the development of high-performance and low-cost sodium ion batteries is a decisive factor in determining whether they can be industrialized.

However, compared with lithium-ion batteries, sodium-ion batteries still have the problems of low energy density and insufficient cycle life. In addition, the high rate and ultra-low temperature discharge performance of sodium-ion batteries are their important advantages over lithium-ion batteries. Therefore, the improvement of long cycle life and high rate capability of sodium-ion batteries is currently a key issue in the research of sodium-ion battery industry. Since the anode is made of carbon-based materials other than graphite, the focus of the current research in the industry is on how to improve the film forming quality of a solid electrolyte interface (SEI) film on an anode so as to improve the battery performance. However, there are few studies on the influence of the intrinsic characteristics (such as microstructure composition/particle size/specific surface area) of anode materials on battery performance; meanwhile, NaFSI is a potential additive and co-salt. However, studies show that it has the disadvantage of corroding the current collector and deteriorating the battery performance, thus limiting its application in sodium-ion batteries and affecting the rate capability and cycling performance of sodium-ion batteries.

### SUMMARY

In view of the above technical problems, the present disclosure provides a sodium-ion battery to overcome the problems of insufficient cycling performance and poor rate capability of sodium-ion batteries in the prior art.

The following technical solution is adopted in the present disclosure:

A sodium-ion battery, comprising a positive electrode, a negative electrode and an electrolyte, wherein the electrolyte comprises an electrolyte salt, an electrolyte additive and a solvent;
a slope area capacity ratio A and a platform area capacity ratio B which correspond to a discharge capacity curve of a coin cell test performed on the negative electrode satisfy the following relationship:

0.66≤A/B≤2.34

wherein, the slope area capacity ratio A is a capacity release ratio in the voltage range of 3.0-0.1V during the coin cell test, and the platform area capacity ratio B is a capacity release ratio in the voltage range of 0.1-0V during the coin cell test, and A+B=1; and
the aforementioned electrolyte comprises NaFSI (sodium bisfluorosulfonylimide) as an electrolyte salt or electrolyte additive; based on 100% of the total mass of the electrolyte, the mass percentage C of the usage amount of NaFSI relative to the electrolyte satisfies: 1%≤C≤15%.

Specifically, the slope area capacity ratio A is a capacity corresponding to 3.0-0.1V in the coin cell test divided by the total capacity, the platform area capacity ratio B is a capacity corresponding to 0.1-0V in the coin cell test divided by the total capacity, and the total capacity is a capacity of 3.0-0V in the coin cell test.

After a large number of experimental studies, the inventor has found that when the ratio between the slope area capacity ratio A to the platform area capacity ratio B satisfies the ratio within a specific range, and combined with the electrolyte containing NaFSI as an electrolyte salt or electrolyte additive and a whole battery is made for test, the battery overcomes the risk of NaFSI corroding a current collector while inhibiting sodium plating, and satisfies the performance advantages of high capacity/high rate and long cycle.

It is found in an experiment that when the ratio of a platform area capacity to the slope area capacity of an anode material used by the battery satisfies 0.66≤A/B≤2.34, it can be ensured that a negative electrode has enough capacity for exertion, and the ratiopositive electrode capacity release to negative electrode capacity release is stabilized, such that Na⁺ deintercalated from a positive electrode can be completely intercalated into the negative electrode, and the plating of Na⁺ at the negative electrode is prevented, thereby effectively inhibiting the occurrence of a sodium plating phenomenon. When A/B<0.66, the capacity release of anode material is too low, resulting in sodium plating from the whole battery, cycling degradation and increased battery safety risk; when A/B>2.34, the capacity release of anode material is also too low, resulting in sodium plating from the whole battery, cycling degradation and increased battery safety risk.

Preferably, in some embodiments of the present disclosure, a slope area capacity ratio and a platform area capacity ratio which correspond to a discharge capacity curve of a coin cell test performed on the negative electrode satisfy the following relationship:

0.81≤A/B≤1.63.

As an electrolyte salt or electrolyte additive, NaFSI can improve the conductivity, electrochemical and thermal stability of an electrolyte, participate in the SEI film forming, reduce side reactions, effectively reduce impedance during battery cycling, and improve cycling performance. The high conductivity of NaFSI can ensure a low use concentration in the electrolyte, and moreover, high conductivity and high capacity exertion can effectively inhibit the occurrence of sodium plating, thus ensuring a long cycle and inhibiting the occurrence of a sodium plating phenomenon.

The mass percentage C of the usage amount of NaFSI relative to the electrolyte satisfies: 1%≤C≤15%. Above this range, the electrolyte viscosity increases, the current collector is corroded, and the active material of pole pieces falls off, which seriously deteriorates the battery performance; below this range, the electrolyte conductivity is too low. Specifically, based on 100% of the total mass of the electrolyte, the mass percentage C of the usage amount of NaFSI relative to the electrolyte can be 1%, 2%, 3%, 4%, 5%, 6%, 7%, 8%, 9%, 10%, 11%, 12%, 13%, 14%, and 15%. Preferably, in some embodiments of the present disclosure, based on 100% of the total mass of the electrolyte, the mass percentage C of the usage amount of NaFSI relative to the electrolyte satisfies: 2%≤C≤11%.

Further, the negative electrode comprises an anode active material, the anode active material is a carbon material, and the carbon material is selected from at least one of hard carbon and soft carbon.

Further, the electrolyte salt comprises one or more of sodium perchlorate (NaClO₄), sodium tetrafluoroborate (NaBF₄), sodium hexafluorophosphate (NaPF₆), sodium trifluoroacetate (CF₃COONa), sodium tetraphenylborate (NaB(C₆H₅)₄), sodium trifluoromethanesulfonate (NaSO₃CF₃), sodium bis(fluorosulfonyl)imide (Na[(FSO₂)₂N]) or sodium bis(trifluoromethylsulfonyl)imide (Na[(CF₃SO₂)₂N]).

Further, the solvent is selected from one or more of C3-C5 carbonate solvents, C2-C6 carboxylic ester solvents and C4-C10 ether solvents; and
based on 100% of the total mass of the electrolyte, the mass percentage of the usage amount of the solvent relative to the electrolyte is 70-92%.

Specifically, in some embodiments of the present disclosure, the carbonate solvents comprise C3-C5 cyclic carbonates or chain carbonates, and the cyclic carbonate is selected from one or more of ethylene carbonate (EC), propylene carbonate (PC), γ-butyrolactone (GBL), and butyl carbonate (BC); the chain carbonate is selected from one or more of dimethyl carbonate (DMC), ethyl methyl carbonate (EMC), diethyl carbonate (DEC), and dipropyl carbonate (DPC); the carboxylic ester solvent is selected from one or more of ethyl propionate (EP), methyl acetate (MA), ethyl acetate (EA), propyl acetate (PA), butyl acetate, and propyl propionate (PP); the ether solvents comprise C4-C10 cyclic ethers or chain ethers, and the cyclic ether is selected from one or more of 1,3-dioxolane (DOL), 1,4-dioxanne (DX), tetrahydrofuran (THF), 2-methyltetrahydrofuran (2-CH₃-THF) and 2-trifluoromethyltetrahydrofuran (2-CF₃-THF); the chain ether is selected from one or more of dimethoxymethane (DMM), 1,2-dimethoxyethane (DME), diethylene glycol dimethyl ether (TEGDME), ethylene glycol diethyl ether, triethylene glycol dimethyl ether and tetraethylene glycol dimethyl ether.

Further, the electrolyte additive is selected from one or more of cyclic carbonate compounds, fluorinated cyclic carbonate compounds, cyclic sulfonic acid ester compounds, cyclic sulfate ester compounds, phosphoric ester compounds, borate ester compounds and nitrile compounds;
preferably, the cyclic carbonate compound is selected from one or more of vinylene carbonate, vinyl ethylene carbonate and methylene vinyl carbonate;
the fluorinated cyclic carbonate compound is selected from one or more of fluoroethylene carbonate and difluoroethylene carbonate;
the cyclic sulfonic acid ester compound is selected from one or more of 1,3-propanesulfone, 1,4-butanesulfone and allenyl-1,3-sulfonolactone;
the cyclic sulfate ester compound is selected from one or more of vinyl sulfate, 4-methylvinyl sulfate and propylene sulfate;
the phosphoric ester compound is selected from one or more of tris(propargyl) phosphate, trimethyl phosphate, triethyl phosphate and tris (trimethylsilane) phosphate;
the borate ester compound is selected from one or more of tris(trimethylsilane)borate and tris(triethylsilane)borate; and
the nitrile compound is selected from one or more of succinonitrile, glutaronitrile, ethylene glycol bis (propionitrile) ether, tricyanohexane, adiponitrile, heptadionitrile, suberic nitrile, nonanedinitrileand sebaconitrile.

Based on 100% of the total mass of the electrolyte, the mass percentage of the usage amount of the electrolyte additive relative to the electrolyte is 1-5%.

Further, the positive electrode comprises a cathode active material, and the cathode active material is selected from one or more of layered transition metal oxides, Prussian compounds, phosphate compounds and sulfate compounds.

Specifically, in some embodiments of the present invention, the chemical formula of the layered transition metal oxide is NaₓM_{y}O_{z}, 0<x≤1, 0<y≤1, 1<z≤2, and M may be selected from one or more of Cr, Fe, Co, Ni, Cu, Mn, Sn, Mo, Sb, and V; the transition metal oxides are NaNiₘFeₙMnₚO₂ (m+n+p=1, 0≤m≤1, 0≤n≤1, 0≤p≤1) and NaNiₘCoₙMnₚO₂ (m+n+p=1, 0≤m≤1, 0≤n≤1, 0≤p≤1); more specifically, the layered transition metal oxide is selected from one or more of Na[Cu_{1/9}Ni_{2/9}Fe_{1/3}Mn_{1/3}]O₂, Na_{0.44}MnO₂, Na_{2/3}[Fe_{1/2}Mn_{1/2}]O₂, Na[Ni_{1/3}Fe_{1/3}Mn_{1/3}]O₂, Na_{7/9}[Cu_{2/9}Fe_{1/9}Mn_{2/3}]O₂, and NaNi_{0.7}Co_{0.15}Mn_{0.15}O₂.

In some embodiments of the present disclosure, the molecular formula of the Prussian compound is NaₓM[M′(CN)₆]_{y}·zH₂O, where M is a transition metal, M′ is a transition metal, 0<x≤2, 0<y≤1, and 0<z≤20; the Prussian compound is NaₓMn[Fe(CN)₆]_{y}·nH₂O (0<x≤2, 0<y≤1, and 0<z≤20), the Prussian compound is NaₓFe[Fe(CN)₆]_{y}·nH₂O (0<x≤2, 0<y≤1, and 0<z≤20).

In some embodiments of the present disclosure, the chemical formula of the phosphate compound is Na₃(MO₁₋ₓPO₄)₂F₁₊₂ₓ, 0≤x≤1, and M is selected from one or more of Al, V, Ge, Fe, and Ga; the chemical formula of the phosphate compound is Na₃(VPO₄)₂F₃ and Na₃(VOPO₄)₂F.

In some embodiments of the present disclosure, the chemical formula of the phosphate compound is Na₂MPO₄F, and M is selected from one or more of Fe and Mn; the chemical formulas of the phosphate compounds are Na₂FePO₄F and Na₂MnPO₄F.

In some embodiments of the present disclosure, the chemical formula of the sulfate compound is Na₂M(SO₄)₂·2H₂O, and M can be selected from one or more of Cr, Fe, Co, Ni, Cu, Mn, Sn, Mo, Sb, and V.

Further, the negative electrode further comprises an anode conductive agent, and the anode conductive agent is selected from one or more of acetylene black, Super P, graphene, Ketjen Black, SFG-6, carbon nanotubes, and graphyne.

Further, the negative electrode further comprises an anode binder, the anode binder is selected from one or more of such thermoplastic resins as polyvinylidene fluoride, vinylidene fluoride copolymer, polytetrafluoroethylene, vinylidene fluoride-hexafluoropropylene copolymer, tetrafluoroethylene-hexafluoropropylene copolymer, tetrafluoroethylene-perfluoroalkyl vinyl ether copolymer, ethylene-tetrafluoroethylene copolymer, vinylidene fluoride-tetrafluoroethylene copolymer, vinylidene fluoride-trifluoroethylene copolymer, vinylidene fluoride-trichloroethylene copolymer, vinylidene fluoride-vinyl fluoride copolymer, vinylidene fluoride-hexafluoropropylene-tetrafluoroethylene copolymer, thermoplastic polyimide, polyethylene and polypropylene; acrylic resins; and styrene butadiene rubbers.

Further, the positive electrode further comprises a cathode conductive agent and a cathode binder, the cathode binder and the cathode conductive agent can be the same as the anode binder and the anode conductive agent, respectively, and are not described repeatedly here.

In some embodiments of the present disclosure, the preparation method of the positive electrode or negative electrode is as follows: Uniformly mix the active material, binder, conductive agent and solvent, coat them on the substrate, and remove the solvent to obtain the positive electrode or negative electrode.

In some embodiments of the present disclosure, the sodium-ion battery further comprises a separator located between the positive electrode and the negative electrode.

The separator can be an existing conventional separator, a ceramic separator, a polymer separator, non-woven fabrics, an inorganic-organic composite separator and so on, including but not limited to single-layer polypropylene (PP), single-layer polyethylene (PE), double-layer PP/PE, double-layer PP/PP, and triple-layer PP/PE/PP.

In some embodiments of the present disclosure, the preparation method of the sodium-ion battery is a general preparation method for secondary batteries, namely, combining a positive electrode, a separator, and a negative electrode, and injecting electrolyte to obtain a sodium-ion battery.

Compared with the prior art, the present disclosure has the following beneficial effects:

The sodium-ion battery of the present disclosure can ensure that a negative electrode has enough capacity for exertion, and a positive electrode capacity release ratio is stabilized, by means of adjusting the ratio between a platform area capacity ratio to the slope area capacity ratio of an anode active material used by the battery, so that Na⁺ deintercalated from a positive electrode can be completely intercalated into the negative electrode, and the plating of Na⁺ at the negative electrode is prevented, thereby effectively inhibiting the occurrence of a sodium plating phenomenon; moreover, NaFSI is used as an electrolyte salt or additive in the electrolyte used and the content range of NaFSI is controlled, such that while the conductivity of the electrolyte is improved, the film forming stability of positive and negative sides of a battery is good, and a current collector does not corrode, thereby effectively improving the rate capability and the cycling stability of the battery.

### BRIEF DESCRIPTION OF THE DRAWINGS

A brief introduction is made below to the FIGURES necessary for the description of the embodiment or the prior art to illustrate the technical solution in the embodiments of the present disclosure or in the prior art more clearly. Apparently, the FIGURES in the following description are only some embodiments of the present disclosure, and those of ordinary skill in the art can derive other drawings from these FIGURES without creative work.

FIG. 1 is a graph illustrating the charge and discharge curves of a negative electrode according to the present disclosure.

### DETAILED DESCRIPTION

The technical solutions in the embodiments of the present disclosure will be clearly and completely described below with reference to the embodiments of the present disclosure. Apparently, the embodiments described are only some rather than all of the embodiments of the present disclosure. Based on the embodiments of the present disclosure, all other embodiments obtained by ordinary persons skilled in the art without creative efforts shall fall within the protection scope of the present disclosure.

### Adjustment Treatment Method of Platform Area Capacity and Slope Area Capacity:

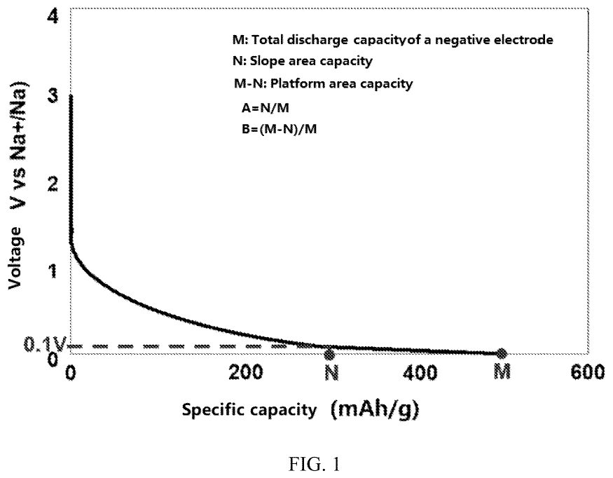

In the present disclosure, the slope area capacity A and the platform area capacity B are obtained by performing a coin half-cell test on a negative electrode. The specific steps are as follows:
(1) Use a LAND test system to test the negative electrode. First, discharge at a current density of 0.1C to 0V, set a voltage range as 0-3.0V, obtain a discharge capacity 1, let it stand for 10 min, charge at a current density of 0.1C to 3.0V, and obtain a charge capacity 2;
(2) According to the procedure of Step (1), a discharge and charge curve of the negative electrode can be obtained; during discharging, the voltage-capacity curve when discharged to 0V is taken as a platform area and slope area curve in the present disclosure, see FIG. 1.

In the present disclosure, the slope area capacity A and the platform area capacity B which correspond to a discharge capacity curve of a coin cell test performed on the negative electrode by using the above method satisfy a relational expression: 0.66≤A/B≤2.34, wherein the slope area capacity A is a capacity release ratio in the voltage range of 0.1-3.0V during the button cell test, and the platform area capacity B is a capacity release ratio in the voltage range of 0.1-0V during the coin cell test, and A+B=1.

In the present disclosure, the adjusting mode of a slope area capacity and a platform area capacity in a coin cell test on the negative electrode is as follows: The ratio (A/B) between the slope area capacity A to the platform area capacity B can be controlled by controlling the particle size of the anode active material in the anode of the sodium-ion battery of the present disclosure, the usage amount of an anode conductive agent and the usage amount of an anode film forming additive in the electrolyte.

When a particle size of the anode active material satisfies 4 μm≤d50≤8 μm, the mass content of the conductive agent in the anode pole piece is 10-5%, and the mass content of the anode film forming additive in the electrolyte is 1%-5%, it can be realized to adjust the slope area capacity A and the platform area capacity B to satisfy the relational expression: 0.66≤A/B≤2.34.

The inventors found that the relationship between the particle size of the anode active material, the usage amount of the anode conductive agent, and the usage amount of the anode film forming additive in the electrolyte and the ratio (A/B) of the slope area capacity A to the platform area capacity B is as follows: With the increase of the anode active material particle size and the usage amount of the anode film forming additive, defects on the anode surface and pores increase, and the ratio of A/B increases; with the increase of the usage amount of the anode conductive agent, sodium ions are more easily intercalated into the negative electrode, and the ratio of A/B decreases. The relationship between the anode active material particle size d50, the usage amount of the anode conductive agent and the usage amount of the anode film forming additive in the electrolyte and A/B can be summarized as shown in Table 1.

TABLE 1

| Influencing Factor | Range of Values | Impact on A/B |
|---|---|---|
| A node active | 4 μm ≤ | The A/B ratio increases |
| material particle | d₅₀ ≤ 8 μm | with the increase of an anode |
| size d50 | | active material particle size |
| Usage amount | 1%-5% | When the usage amount of the |
| of anode conductive | | anode conductive agent increases, |
| agent | | the A/B ratio decreases |
| Usage amount of | 1%-5% | When the usage |
| the anode | | amount of the film forming |
| film forming additive | | additive increases, the A/B |
| in the electrolyte | | ratio increases |

For example, an example of adjusting the ratio A/B by controlling the anode active material particle size d50, the usage amount of the anode conductive agent, and the usage amount of the anode film forming additive in the electrolyte can be seen in Table 2.

TABLE 2

| | | Usage Amount | Usage Amount | |
|---|---|---|---|---|
| | | of Conductive | of Film Forming | |
| | d50/μm | Agent/wt. % | Additive/wt. % | A/B |
| Embodiment 1 | 5.5 | 2 | 2.5 | 1.63 |
| Embodiment 2 | 4.5 | 3 | 1 | 0.82 |
| Embodiment 3 | 4.5 | 5 | 1 | 0.66 |
| Embodiment 4 | 4.5 | 4 | 1 | 0.75 |
| Embodiment 5 | 4.5 | 3 | 2 | 0.98 |
| Embodiment 6 | 4.5 | 2 | 2 | 1.16 |
| Embodiment 7 | 5 | 2 | 2 | 1.34 |
| Embodiment 8 | 6 | 2 | 2.5 | 1.89 |
| Embodiment 9 | 7 | 1 | 3.5 | 2.12 |
| Embodiment 10 | 8 | 1 | 5 | 2.34 |

### Embodiments 1-18

The present disclosure provides a sodium-ion battery comprising a positive electrode, a negative electrode and an electrolyte.

### (1) Preparation of Electrolyte

Mix ethylene carbonate (EC), propylene carbonate (PC), and diethyl carbonate (DEC) at a mass ratio of 2:1:7; based on 100% of the total mass of the electrolyte, add NaFSI with a mass percentages shown in Table 3, 5.6% sodium hexafluorophosphate (NaPF₆), and 2% fluorinated ethylene carbonate as an anode film forming additive.

### (2) Preparation of Positive Plate

Mix NaNi_{1/3}Fe_{1/3}Mn_{1/3}O₂, a cathode active material, Super-P, a conductive carbon black, and polyvinylidene fluoride (PVDF), a binder, at a mass ratio of 93:4:3, and then disperse them in an appropriate amount of N-methyl-2-pyrrolidone (NMP) to obtain a cathode slurry; evenly coat the obtained slurry on both sides of an aluminum foil, after drying, calendering, vacuum drying, and welding it with an aluminum lead wire by an ultrasonic welder to obtain a positive plate with a thickness of 120-150 μm.

### (3) Preparation of Negative Plate

Mix hard carbon, Super-P, a conductive carbon black, styrene butadiene rubber (SBR), a binder, and carboxymethyl cellulose (CMC) at a mass ratio of 94:1:2.5:2.5, and then disperse them in an appropriate amount of deionized water to obtain an anode slurry; coat the slurry on both sides of a copper foil, after drying, calendering, vacuum drying, and welding it with a nickel lead wire by an ultrasonic welder to obtain a negative plate with a thickness of 120-150 μm; the proportional relationship A/B of the slope area capacity ratio A to the platform area capacity ratio B in hard carbon is as shown in Table 3.

### (4) Preparation of Battery Cell

A triple-layer separator with a thickness of 20 μm is placed between the above prepared positive plate and negative plate, then a sandwich structure composed of the positive plate, the negative plate and the separator is wound, then further a wound body is flattened and put into an aluminum foil packaging bag, and vacuum baking it at 75° C. for 48 hours to obtain a battery cell to be injected with liquid.

### (5) Liquid Injection and Formation of Battery Cell

Inject the above prepared electrolyte into the battery cell in a glove box with a dew point controlled below −40° C., package it in vacuum and let it stand for 24 hours.

The regular formation for charging is as follows: charge at a 0.05C constant current for 180 min, charge at a 0.2C constant current to 3.95V, carry out a secondary vacuum sealing, further charge at a 0.2C constant current to 4.2V, stand still at a room temperature for 24 hours, and then discharge at a 0.2C constant current to 3.0V. In this way, a sodium-ion battery is obtained.

### Comparative Examples 1-5

Comparative Examples 1-5 include most of the operation steps in the above embodiments, and their difference lies in: In a process of preparing the electrolyte, based on 100% of the total mass of the electrolyte, add NaFSI with a mass percentage as shown in Comparative Examples 1-5 in Table 3, and anode active materials with values of the slope area capacity ratio A and the platform area capacity ratio B and their proportional relationship A/B as shown in Comparative Examples 1-5 in Table 3 to obtain test results, and fill them into Table 3.

### Performance Tests

The following performance tests are performed on the sodium-ion batteries prepared in Embodiments 1-18 and Comparative Examples 1-5:

Test on conductivity of the electrolyte at 25° C.: Test each group of the prepared electrolyte with a conductivity meter at 25° C.

Sodium plating test: At 25° C., charge a battery at a constant current of 1C and a constant voltage of 3.95V, respectively, and then cut off charging at 0.03C and cut off discharging at 1C/1.5V. Thereafter, after 50 cycles, disassemble the battery and evaluate its effect on suppressing sodium plating from the anode.

Discharge capacity ratio at 4C rate: the ratio of the capacity released by a battery from 3.95-1.5V at 4C rate to the capacity released by the battery at 0.2C rate in an activation phase.

High/room temperature cycle test: Leave a formed battery at 45° C./25° C. for 2 hours, charge it to 3.9V at a constant current of 0.5C, then charge it at a constant voltage until the current is 0.03C, and then discharge it to 1.5V at a constant current of 1C for 200 cycles; and

capacity retention rate (%)=(discharge capacity C2−charge capacity C1)/charge capacity C1×100%.

The test results are shown in Table 3.

TABLE 3

| | | | | | | | Capacity | Capacity | Whether | Analysis of |
|---|---|---|---|---|---|---|---|---|---|---|
| | | | | | | Discharge | Retention | Retention | the | Sodium |
| | Slope | Platform | | Mass | Conductivity | Capacity | Rate After | Rate After | Current | Plating |
| | Area | Area | | Percentage | of the | Ratio at | 200 Cycles | 200 Cycles | Collector | Phenomenon |
| | Capacity | Capacity | | of | Electrolyte | 4 C | at a Room | at a High | Is | after 50 |
| Group | Ratio A | Ratio B | A/B | NaFSI/% | at 25° C./% | Rate/% | Temperature/% | Temperature/% | Corroded | Cycles |
| Embodi- | 0.62 | 0.38 | 1.63 | 11 | 7.89 | 92.1 | 97 | 96.5 | No | No sodium |
| ment 1 | | | | | | | | | | plating |
| | | | | | | | | | | observed |
| Embodi- | 0.45 | 0.55 | 0.82 | 11 | 7.89 | 92.9 | 96.8 | 96.3 | No | No sodium |
| ment 2 | | | | | | | | | | plating |
| | | | | | | | | | | observed |
| Embodi- | 0.40 | 0.60 | 0.67 | 11 | 7.89 | 87.2 | 92.9 | 94.1 | No | No sodium |
| ment 3 | | | | | | | | | | plating |
| | | | | | | | | | | observed |
| Embodi- | 0.43 | 0.57 | 0.75 | 11 | 7.89 | 87.9 | 93.4 | 92.6 | No | No sodium |
| ment 4 | | | | | | | | | | plating |
| | | | | | | | | | | observed |
| Embodi- | 0.49 | 0.51 | 0.96 | 11 | 7.89 | 93.1 | 94.3 | 94.8 | No | No sodium |
| ment 5 | | | | | | | | | | plating |
| | | | | | | | | | | observed |
| Embodi- | 0.54 | 0.46 | 1.17 | 11 | 7.89 | 93.4 | 94.9 | 94.9 | No | No sodium |
| ment 6 | | | | | | | | | | plating |
| | | | | | | | | | | observed |
| Embodi- | 0.57 | 0.43 | 1.33 | 11 | 7.89 | 93.6 | 95.6 | 95.1 | No | No sodium |
| ment 7 | | | | | | | | | | plating |
| | | | | | | | | | | observed |
| Embodi- | 0.65 | 0.35 | 1.86 | 11 | 7.89 | 91.7 | 93.8 | 93.2 | No | No sodium |
| ment 8 | | | | | | | | | | plating |
| | | | | | | | | | | observed |
| Embodi- | 0.68 | 0.32 | 2.13 | 11 | 7.89 | 92 | 94.2 | 94.3 | No | No sodium |
| ment 9 | | | | | | | | | | plating |
| | | | | | | | | | | observed |
| Embodi- | 0.70 | 0.30 | 2.33 | 11 | 7.89 | 92.1 | 94.1 | 93.4 | No | No sodium |
| ment 10 | | | | | | | | | | plating |
| | | | | | | | | | | observed |
| Embodi- | 0.62 | 0.38 | 1.63 | 1 | 4.92 | 84.2 | 89.8 | 87.2 | No | No sodium |
| ment 11 | | | | | | | | | | plating |
| | | | | | | | | | | observed |
| Embodi- | 0.62 | 0.38 | 1.63 | 2 | 5.61 | 87.4 | 93.2 | 92.5 | No | No sodium |
| ment 12 | | | | | | | | | | plating |
| | | | | | | | | | | observed |
| Embodi- | 0.62 | 0.38 | 1.63 | 4 | 6.26 | 88.9 | 94.2 | 93.4 | No | No sodium |
| ment 13 | | | | | | | | | | plating |
| | | | | | | | | | | observed |
| Embodi- | 0.62 | 0.38 | 1.63 | 7 | 6.92 | 90.6 | 95.5 | 94.8 | No | No sodium |
| ment 14 | | | | | | | | | | plating |
| | | | | | | | | | | observed |
| Embodi- | 0.62 | 0.38 | 1.63 | 9 | 7.43 | 91.3 | 96.1 | 95.3 | No | No sodium |
| ment 15 | | | | | | | | | | plating |
| | | | | | | | | | | observed |
| Embodi- | 0.62 | 0.38 | 1.63 | 11 | 7.89 | 92 | 97 | 96.5 | No | No sodium |
| ment 16 | | | | | | | | | | plating |
| | | | | | | | | | | observed |
| Embodi- | 0.62 | 0.38 | 1.63 | 13 | 8.62 | 90.1 | 95.5 | 94.8 | No | No sodium |
| ment 17 | | | | | | | | | | plating |
| | | | | | | | | | | observed |
| Embodi- | 0.62 | 0.38 | 1.63 | 15 | 9.87 | 86.5 | 94.2 | 93.3 | No | No sodium |
| ment 18 | | | | | | | | | | plating |
| | | | | | | | | | | observed |
| Comparative | 0.38 | 0.62 | 0.61 | 11 | 7.89 | 68 | 83.5 | 81.9 | No | Extensive |
| Example 1 | | | | | | | | | | foamy |
| | | | | | | | | | | sodium |
| | | | | | | | | | | plating |
| | | | | | | | | | | occurs |
| Comparative | 0.71 | 0.29 | 2.45 | 11 | 7.89 | 65 | 84.6 | 83.2 | No | Extensive |
| Example 2 | | | | | | | | | | foamy |
| | | | | | | | | | | sodium |
| | | | | | | | | | | plating |
| | | | | | | | | | | occurs |
| Comparative | 0.62 | 0.38 | 1.63 | 0 | 4.12 | 42 | 80.3 | 79.5 | No | No sodium |
| Example 3 | | | | | | | | | | plating |
| | | | | | | | | | | observed |
| Comparative | 0.62 | 0.38 | 1.63 | 0.5 | 4.48 | 51 | 83.6 | 82.7 | No | No sodium |
| Example 4 | | | | | | | | | | plating |
| | | | | | | | | | | observed |
| Comparative | 0.62 | 0.38 | 1.63 | 18 | 8.87 | 86 | 89.4 | 88.2 | Serious | No sodium |
| Example 5 | | | | | | | | | corrosion | plating |
| | | | | | | | | | occurs | observed |

It can be seen from the test results of Embodiments 1-18 that when the ratio between a platform area capacity ratio to the slope area capacity ratio at an anode material used by the battery satisfies 0.66≤A/B≤2.34, it can be ensured that a negative electrode has enough capacity for exertion, and a positive electrode capacity release ratio is stabilized, so that Na⁺ deintercalated from a positive electrode can be completely intercalated into the negative electrode, and the plating of Na⁺ at the negative electrode is prevented, thereby effectively inhibiting the risk of sodium plating of the battery; moreover, controlling the usage amount of NaFSI in the electrolyte is conducive to improving the cycling performance of sodium-ion batteries, increasing the rate capability and inhibiting the risk of sodium plating, thus enhancing the safety performance of batteries. From the test results of Embodiments 1-10 and Comparative Examples 1-2, it can be seen that when the ratio A/B of a platform area capacity ratio to a slope area capacity ratio is too high or too low, not only sodium plating will occur, but also the rate and cycle performance of the battery will be reduced. This is because the platform area capacity and the slope area capacity can control the influence of different sodium storage mechanisms of sodium ions in anode materials to some extent, but the degree of reduction is less than that of NaSFI. From the test results of Examples 11-18 and Comparative Examples 3-5, it can be seen that a certain content of NaSFI used as an electrolyte additive or electrolyte salt can improve the conductivity, electrochemical stability and thermal stability of the electrolyte, participate in the formation of SEI film, reduce side reactions, and effectively reduce impedance during a battery cycle. When the content of NaSFI is too high, the viscosity of the electrolyte will increase and the electrolyte will corrode the current collector. The active material on the pole piece will fall off, seriously degrading the battery performance; when the content of NaSFI is too low, the conductivity of electrolyte will be too low.

To sum up, the present disclosure provides a sodium-ion battery, which can ensure that a negative electrode has enough capacity for exertion, and a positive electrode capacity release ratio is stabilized, by means of adjusting the ratio between a platform area capacity ratio to the slope area capacity ratio of an anode active material used by the battery, so that Na⁺ deintercalated from a positive electrode can be completely intercalated into the negative electrode, and the plating of Na⁺ at the negative electrode is prevented, thereby effectively inhibiting the occurrence of a sodium plating phenomenon; moreover, NaFSI is used as an electrolyte salt or additive in the electrolyte used and the content range of NaFSI is controlled, such that while the conductivity of the electrolyte is improved, the film forming stability of positive and negative sides of a battery is good, and a current collector does not corrode, thereby effectively improving the rate capability and the cycling stability of the battery.

The present disclosure has been further described above with reference to specific embodiments, but it should be understood that the specific description herein shall not be construed as limiting the essence and scope of the present disclosure. All modifications made by ordinary persons skilled in the art to the above embodiments after reading this specification fall within the protection scope of the present disclosure.

What is claimed:

1. A sodium-ion battery, comprising a positive electrode, a negative electrode and an electrolyte, wherein the electrolyte comprises an electrolyte salt, an electrolyte additive and a solvent;
a slope area capacity ratio A and a platform area capacity ratio B which correspond to a discharge capacity curve of a coin cell test performed on the negative electrode satisfy the following relationship:
0.66≤A/B≤2.34
wherein, the slope area capacity ratio A is a capacity release ratio in the voltage range of 3.0-0.1V during the button cell test, and the platform area capacity ratio B is a capacity release ratio in the voltage range of 0.1-0V during the button cell test, and A+B=1; and
the electrolyte comprises NaFSI as an electrolyte salt or electrolyte additive; based on 100% of the total mass of the electrolyte, the mass percentage C of the usage amount of NaFSI relative to the electrolyte satisfies: 1%≤C≤15%.

2. The sodium-ion battery according to claim 1, wherein a slope area capacity ratio A and a platform area capacity ratio B which correspond to a discharge capacity curve of a button cell test performed on the negative electrode satisfy the following relationship:
0.81≤A/B≤1.63.

3. The sodium-ion battery according to claim 1, wherein based on 100% of the total mass of the electrolyte, the mass percentage C of the usage amount of NaFSI relative to the electrolyte satisfies: 2%≤C≤11%.

4. The sodium-ion battery according to claim 1, wherein the negative electrode comprises an anode active material, and the anode active material is a carbon material; and
the carbon material is selected from at least one of hard carbon and soft carbon.

5. The sodium-ion battery according to claim 1, wherein the electrolyte salt comprises one or more of sodium perchlorate, sodium tetrafluoroborate, sodium hexafluorophosphate, sodium trifluoroacetate, sodium tetraphenylborate, sodium trifluoromethanesulfonate, sodium bis(fluorosulfonyl)imide or sodium bis(trifluoromethylsulfonyl)imide.

6. The sodium-ion battery according to claim 1, wherein the solvent is selected from one or more of C3-C5 carbonate solvents, C2-C6 carboxylic ester solvents and C4-C10 ether solvents; and
based on 100% of the total mass of the electrolyte, the mass percentage of the usage amount of the solvent relative to the electrolyte is 70-92%.

7. The sodium-ion battery according to claim 6, wherein:
the carbonate solvents comprise C3-C5 cyclic carbonates or chain carbonates, and the cyclic carbonate is selected from one or more of ethylene carbonate, propylene carbonate, γ-butyrolactone, and butyl carbonate; the chain carbonate is selected from one or more of dimethyl carbonate, ethyl methyl carbonate, diethyl carbonate, and dipropyl carbonate;
the C2-C6 carboxylic ester solvent is selected from one or more of ethyl propionate, methyl acetate, ethyl acetate, propyl acetate, butyl acetate, and propyl propionate; and
the ether solvents comprise C4-C10 cyclic ethers or chain ethers, the cyclic ether is selected from one or more of 1,3-dioxolane, 1,4-dioxanne, tetrahydrofuran, 2-methyltetrahydrofuran and 2-trifluoromethyltetrahydrofuran, and the chain ether is selected from one or more of dimethoxymethane, 1,2-dimethoxyethane, diethylene glycol dimethyl ether, ethylene glycol diethyl ether, triethylene glycol dimethyl ether and tetraethylene glycol dimethyl ether.

8. The sodium-ion battery according to claim 1, wherein the electrolyte additive is selected from one or more of cyclic carbonate compounds, fluorinated cyclic carbonate compounds, cyclic sulfonic acid ester compounds, cyclic sulfate ester compounds, phosphoric ester compounds, borate ester compounds and nitrile compounds;
preferably, the cyclic carbonate compound is selected from one or more of vinylene carbonate, vinyl ethylene carbonate and methylene vinyl carbonate;
the fluorinated cyclic carbonate compound is selected from one or more of fluoroethylene carbonate and difluoroethylene carbonate;
the cyclic sulfonic acid ester compound is selected from one or more of 1,3-propanesulfone, 1,4-butanesulfone and allenyl-1,3-sulfonolactone;
the cyclic sulfate ester compound is selected from one or more of vinyl sulfate, 4-methylvinyl sulfate and propylene sulfate;
the phosphoric ester compound is selected from one or more of tris(propargyl) phosphate, trimethyl phosphate, triethyl phosphate and tris (trimethylsilane) phosphate;
the borate ester compound is selected from one or more of tris(trimethylsilane)borate and tris(triethylsilane)borate; and
the nitrile compound is selected from one or more of succinonitrile, glutaronitrile, ethylene glycol bis (propionitrile) ether, tricyanohexane, adiponitrile, heptadionitrile, suberic nitrile, nonanedinitrile and sebaconitrile.

9. The sodium-ion battery according to claim 8, wherein based on 100% of the total mass of the electrolyte, the mass percentage of the usage amount of the electrolyte additive relative to the electrolyte is 1-5%.

10. The sodium-ion battery according to any one of claim 1, wherein the positive electrode comprises a cathode active material, and the cathode active material is selected from one or more of layered transition metal oxides, Prussian compounds, phosphate compounds and sulfate compounds;
preferably, the chemical formula of the layered transition metal oxide is NaₓM_{y}O_{z}, 0<x≤1, 0<y≤1, 1<z≤2, and M is selected from one or more of Cr, Fe, Co, Ni, Cu, Mn, Sn, Mo, Sb, and V; the transition metal oxides are NaNiₘFeₙMnₚO₂ (m+n+p=1, 0≤m≤1, 0≤n≤1, 0≤p≤1) and NaNiₘCoₙMnₚO₂ (m+n+p=1, 0≤m≤1, 0≤n≤1, 0≤p≤1);
the molecular formula of the Prussian compound is NaₓM[M′(CN)₆]_{y}·zH₂O, where M is a transition metal, M′ is a transition metal, 0<x≤2, 0<y≤1, and 0<z≤20;
the chemical formula of the phosphate compound is Na₃(MO₁₋ₓPO₄)₂F₁₊₂ₓ, 0≤x≤1, and M is selected from one or more of Al, V, Ge, Fe, and Ga; and
the chemical formula of the sulfate compound is Na₂M (SO₄)₂·2H₂O, and M is selected from one or more of Cr, Fe, Co, Ni, Cu, Mn, Sn, Mo, Sb, and V.
